(19) United States
(12) Patent Application Publication
(10) Pub. No.: US 2002/0048333 A1
(43) Pub. Date: Apr. 25, 2002

(54) Joint detection in OFDM systems

(76) Inventors: Nadeem Ahmed, Houston, TX (US); Richard G. Baraniuk, Houston, TX (US); Rohit V. Gaikwad, Houston, TX (US)

Correspondence Address: CONLEY ROSE & TAYON, P.C., P. O. BOX 3267, HOUSTON, TX, 77253-3267, US

(21) Appl. No.: 09/865,238

(22) Filed: May 25, 2001

Related U.S. Application Data
(60) Provisional application No. 60/206,893, filed on May 25, 2000.

(51) Int. Cl. H04L 1/00

(52) U.S. Cl. 375/346

(57) ABSTRACT

A communications system is disclosed having an improved receiver designed to combat ICI in OFDM modulated signals. The receiver may also be designed to combat ISI in OFDM modulated signals. In one embodiment, the communications system comprises a transmitter that transmits an OFDM modulated signal, and a receiver that receives and demodulates a corrupted version of the OFDM modulated signal. The receiver includes an A/D converter, a transform module, and a detection module. The A/D converter converts the corrupted OFDM-modulated signal into a digital receive signal. The transform module transforms the digital receive signal into the frequency domain. The detection module determines a channel symbol from the frequency component amplitudes while compensating for correlation between the frequency components. In a preferred implementation, the detection module calculates for each frequency component, a weighted sum of the frequency component amplitudes from the transform module. The weighted sum minimizes expected error energy.

### RELATED APPLICATIONS

Provisional U.S. patent application Ser. No. 60/206,893, filed May 25, 2000 (Attorney Docket No. 1789-04800) is hereby incorporated by reference.

### BACKGROUND OF THE INVENTION

1. Field of the Invention

The present invention relates generally to methods and systems for digital communication. More particularly, the present invention relates to detection techniques for improving the performance of orthogonal frequency division multiplexing (OFDM) and discrete multi-tone (DMT) systems.

2. Description of the Related Art

The development of humankind has been characterized by tools. Archaeologists routinely refer to various stages of human development using such terminology as “The Stone Age”, “The Iron Age”, the “The Industrial Revolution”, and “The Atomic Age”, just to name a few. The present stage of civilization has been aptly named “The Information Age”, reflecting our ability to access and manipulate great volumes of information. The tools underlying these abilities include powerful computers and high speed communications networks.

The field of digital communications is relatively young, having only had its fundamental principles laid out in 1948 by Claude Shannon. Further, it is only within the last ten years or so that technology has enabled truly efficient use of communications resources. One popular technique that allows efficient use of communications channels is orthogonal frequency division multiplexing (OFDM), sometimes also referred to as discrete multi-tone signaling (DMT).

OFDM systems divide the available communications bandwidth of a channel into a set of “bins”, each bin having the same frequency width. In each symbol interval, the bits of a data word are apportioned among the bins in accordance with the signal-to-noise ratio of each bin. Those bins having higher signal-to-noise ratios are allocated more bits than those bins having lower signal-to-noise ratio. The allocation of bits to bins can be made in accordance with a formula or adaptation algorithm so as to maximize the utilization of the channel. A frequency carrier for each bin is amplitude modulated to reflect the value of the corresponding bits. In this manner, near-optimal use of the available channel spectrum may be achieved.

To avoid having to generate a separate frequency carrier for each bin, commercial implementations of OFDM systems rely on an inverse discrete Fourier Transform (IDFT) modulation technique. In this technique, the allocated bits are treated as frequency coefficients of a discrete Fourier Transform (DFT), and an inverse transform is applied to obtain the corresponding time domain sample sequence. This sample sequence could then be converted to analog form and transmitted across the channel.

However, to simplify the receiver structure, commercial OFDM systems augment the time domain sample sequence by prefixing a cyclic prefix to the sample sequence. The cyclic prefix is a duplication of the last portion of the sample sequence. This cyclic prefix makes the received symbol appear cyclic, which allows the transmission of data trough the channel to be modeled as a circular convolution. This diminishes the need for sophisticated equalization techniques in the receiver. The intersymbol interference that trails from the last portion of the sample sequence of one OFDM symbol overlaps the first portion of the sample sequence of the next OFDM symbol. The receivers generally demodulate the received symbol by trimming off the cyclic prefix and performing a DFT on the sample sequence. Channel equalization may be performed in the frequency domain by simple scaling of the DFT coefficients. The coefficients values indicated the transmitted bit values, which can then be reassembled to obtain the transmitted data word. Commercial OFDM systems include high-speed modems and digital broadcast systems.

OFDM systems commonly use rectangular pulses for data modulation, although other pulse shapes are sometimes employed. Because rectangular pulses require widespread support in the frequency domain, OFDM systems have a significant spectral overlap with a large number of adjacent subchannels. FIG. 1 shows the overlap that would exist in a 5-bin system. When the channel distortion is mild relative to the channel bandwidth, data can be demodulated with a very small amount of interference from the other subchannels, due to the orthogonality of the transformation. Subchannel isolation is retained only for channels which introduce virtually no distortion. Of course, typical channels lack this desirable characteristic.

Channel distortion causes two kinds of interference: intersymbol interference (ISI) and interchannel interference (ICI). ISI occurs when the dispersive effects of the channel cause energy from one OFDM symbol to “leak” into the next. ICI occurs when the channel causes energy from one bin to leak into others. Equalization is the standard method for combating both types of interference, and as long as the cyclic prefix is longer than the delay spread of the channel, the equalization may be performed in the frequency domain. However, most channels would require a prohibitively long cyclic prefix, and many equalization techniques have proven inadequate.

It is also worth noting that in systems that employ non-rectangular pulse shapes, the subchannels may be correlated even before transmission through the channel. Existing systems fail to correct for this ICI.

### SUMMARY OF THE INVENTION

Accordingly, there is disclosed herein a communications system having an improved receiver designed to combat ICI in OFDM modulated signals. The receiver may also be designed to combat ISI in OFDM modulated signals. In one embodiment, the communications system comprises a transmitter that transmits an OFDM modulated signal, and a receiver that receives and demodulates a corrupted version of the OFDM modulated signal. The receiver includes an A/D converter, a transform module, and a detection module. The A/D converter samples the corrupted OFDM-modulated signal to obtain a digital receive signal. The transform module determines frequency component amplitudes of the digital receive signal. The detection module determines a channel symbol from the frequency component amplitudes while compensating for correlation between the frequency components. The detection module may also remove trailing ISI from previous symbols before determining a channel symbol. In a preferred implementation, the detection module calculates for each frequency component, a weighted sum of the frequency component amplitudes from the transform module. The weighted sum is preferably designed to minimize expected error energy observed by the decision element.

### BRIEF DESCRIPTION OF THE DRAWINGS

A better understanding of the present invention can be obtained when the following detailed description of the preferred embodiment is considered in conjunction with the following drawings, in which:

FIG. 1 shows the spectral overlap of channels in an OFDM system;

FIG. 2 shows a conceptual model of a conventional OFDM system;

FIG. 3 shows a first embodiment of a modified receiver in an OFDM system;

FIG. 4 shows a second embodiment of a modified receiver;

FIG. 5 shows a third embodiment of a modified receiver;

FIGS. 6A and 6B show a spectrum of channel and a comparison of simulated receiver performances on that channel;

FIGS. 7A and 7B show a second channel spectrum and a comparison of simulated receiver performances on that channel;

FIGS. 8A and 8B show a third channel spectrum and a comparison of simulated receiver performances on that channel;

FIGS. 9A and 9B show a fourth channel spectrum and a comparison of simulated receiver performances on that channel; and

FIGS. 10A and 10B show a fifth channel spectrum and a comparison of simulated receiver performances on that channel.

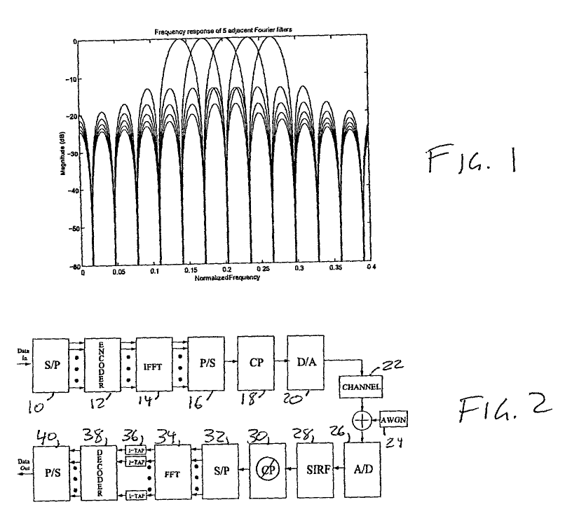

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION OF THE PREFERRED EMBODIMENT

Fundamentally, OFDM systems superimpose several carrier-modulated waveforms to represent an input bit stream. The transmitted signal is the sum of M independent sub-signals, each typically of equal bandwidth with center frequency fᵢ, i=1, 2, . . . , M. Generation and modulation of the subchannels is accomplished digitally, using the FFT operation on each of a sequence of blocks in a data stream. Each of these sub-signals can be considered a quadrature amplitude modulated (QAM) signal. In contrast with conventional frequency division multiplexing, the number of bits allocated to the different subchannels can be different. This allows data to be multiplexed on subchannels in a manner that maximizes performance: subchannels that experience less attenuation over the channel will carry more information.

Refer now to FIG. 2. A conventional OFDM system conceptually comprises a serial-to-parallel (S/P) converter 10, an encoder 12, an inverse fast Fourier Transform (IFFT) module 14, a parallel-to-serial (P/S) converter 16, a cyclic prefix generator 18, a digital-to-analog (D/A) converter 20, a channel 22, a noise source 24, an analog-to-digital (AID) converter 26, a time-domain equalizer 28, a cyclic prefix remover 30, an S/P converter 32, a fast Fourier Transform (FFT) module 34, scaling mask 36, decoder 38, and a P/S converter 40.

The transmitter accepts serial data and converts it into a lower sequences via serial to parallel converter 10. These lower rate sequences are encoded by encoder 12 to give sequences of channel symbols, which are then frequency division multiplexed via an IFFT 14. The parallel outputs of the IFFT 14 are converted to serial form by P/S converter 16, and a cyclic prefix is added by generator 18. Transmission is then initiated by D/A converter 20. The communications channel 22 distorts the signal as it transfers the signal to the receiver, and an additive white gaussian noise (AWGN) source 24 corrupts the signal.

The receiver samples the received signal and converts it from analog to digital form via A/D converter 26. An equalizer 28 may be used to effectively shorten the impulse response of the overall channel, preferably to less than the length of the cyclic prefix. The cyclic prefix remover 30 drops the cyclic prefix, and S/P converter 32 converts the received sample stream into a set of reduced-rate sample streams. The FFT module 34 converts the reduced-rate sample streams into received channel symbol streams, which are then scaled in accordance with mask 36 and decoded by decoder 38 to obtain reduced-rate received data streams. The P/S converter 40 combines the reduced-rate received data streams into a single received data stream.

When the impulse response of the channel is shorter than the length of the cyclic prefix, the data appears periodic to the transmission channel. This allows the scaling mask 36 to eliminate all ISI and ICI. Practical OFDM systems employ a time domain equalizer 28 that is designed to make the length of the effective channel impulse response shorter than the cyclic prefix, but their effectiveness is limited, resulting in significant energy leakage outside the cyclic prefix. As a result, neither ISI nor ICI is eliminated. In conventional systems, this severely degrades the system performance.

We propose alternative detection strategies that improve the performance of OFDM systems in the presence of ISI and ICI. The strategies include: optimal joint-channel detection, suboptimal joint-channel detection, and combined joint-symbol, joint-channel detection. Simulation results are also provided, showing the significant performance improvement offered by the proposed detection strategies.

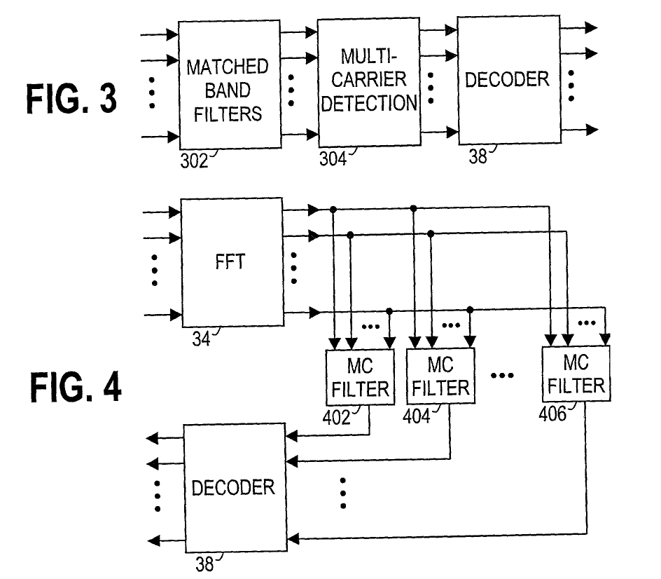

FIG. 3 shows a portion of an OFDM receiver in which the FFT module 34 and the scaling mask 36 are respectively replaced by a set of matched-band filters 302 and an optimal multi-carrier detector 304. The multi-carrier detector identifies the most likely vector of transmitted data values given the output vector from the filters 302. This is done by an exhaustive search over all possible vectors of data values in each symbol interval to determine the most likely one. The detector 304 preferably chooses the data vector (d₀, d₁, . . . , d_{K-1}) that maximizes the likelihood function:

$${\text{argmax}}_{{d}_{0} , {d}_{1} , … {d}_{K - 1}} \{ exp ( \frac{- 1}{2 {σ}^{2}} {\int }_{0}^{T} {[ r ( t ) - \tilde{y} ( t ) ]}^{2} ⅆ t ) \}$$

where \tilde{y}(t) is the modeled output of the channel for a given data vector, r(t) is the received signal, T is the symbol period, and σ is the channel noise power.

In one specific case, an ADSL modem uses a “real baseband representation”. In modems using this representation, the complex carriers fᵢ(t) are expressed in terms of in-phase gᵢ(t) and quadrature-phase hᵢ(t) components:

$${f}_{i} ( t ) = {g}_{i} ( t ) + {jh}_{i} ( t ) = cos ( \frac{2 π it}{K} ) + j sin ( \frac{2 π it}{K} )$$

Imposing the requirement that the transmitted signal have a baseband representation with no imaginary components (i.e. real-valued), the received signal r(t) can be represented:

$$r ( t ) = {A}_{0} {c}_{0} {\tilde{g}}_{0} ( t ) + {A}_{M} {c}_{M} {\tilde{g}}_{M} ( t ) + {\sum }_{i = 1}^{M - 1} 2 {A}_{i} ( {a}_{i} {\tilde{g}}_{i} ( t ) - {b}_{i} {\tilde{h}}_{i} ( t ) ) + σ n ( t ) ,$$

where K=2M is the order of the IFFT transform, Aᵢ, i=0, 1, . . . , M, is the scaling factor of the i^{th} carrier frequency at the time of transmission, \tilde{g}ᵢ(t), i=1, . . . , M−1, are the received (i.e. channel-distorted) in-phase carriers, \tilde{h}ᵢ(t), i=1, . . . , M−1, are the received quadrature-phase carriers, σn(t) is the noise component of the signal, and (c₀, C_{M}, a₁, . . . , a_{M-1}, b₁, . . . , b_{M-1}) is the set of data values modulated into the transmit signal.

The matched bandpass filters 304 (i.e. a bank of filters having impulse responses gᵢ^{*}(t) and hᵢ^{*}(t)) take the received signal r(t) and determine a vector of matched bandpass filter outputs (r_{g,0}, r_{g,M}, r_{g,1}, . . . r_{g,M-1}, r_{h,1}, . . . , r_{h,M-1}). The detector 304 then determines that the most likely data value vector (c₀, C_{M}, a₁, . . . , a_{M-1}, b₁, . . . , b_{M-1}) is the one that minimizes:

4[A₀c₀a^{T}A(GG₀)−A₀c₀b^{T}A(GH₀)+A_{M}c_{M a^{T}}A(GG_{M})−A_{M}c_{M}b^{T}A(GH_{M})]+4[a^{T}A(GG)Aa−a^{T}A(GH)Ab−b^{T}A(HG)Aa+b^{T}A(HH)Ab]+2A₀A_{M}c₀c_{M}GG_{0M}−2[A₀c₀r_{g}_{₀}+A_{M}c_{M}r_{g}_{₀}]−4[a^{T}Ar_{g}−b^{T}Arₕ]

where, a is the column vector (a₁, . . . , a_{M-1})^{T}, b is the column vector (b₁, . . . , b_{M-1})^{T}, A is a diagonal matrix of scaling factors diag(A₁, . . . , A_{M-1}), GG=[\tilde{g}ᵢ(t)\tilde{g}ⱼ(t)] is a correlation matrix between received in-phase carriers \tilde{g}ᵢ(t), i=1, . . . , M−1, GH=HG^{T}=[\tilde{g}ᵢ(t)\tilde{h}ⱼ(t)] is a correlation matrix between received in-phase carriers and the received quadrature phase carriers \tilde{h}ⱼ(t), j=1, . . . , M−1, and HH=[\tilde{h}ᵢ(t)\tilde{h}ⱼ(t)] is a correlation matrix between the received quadrature phase carriers. The column vector (GG₀) is defined by correlation values [\tilde{g}ᵢ(t)\tilde{g}₀(t)], i=1, . . . , M−1, the column vector (GH₀) is defined by correlation values [\tilde{g}ᵢ(t)\tilde{h}₀(t)], i=1, . . . , M−1, the column vector (GG_{M}) is defined by correlation values [\tilde{g}ᵢ(t)\tilde{g}_{M}(t)], i=1, . . . , M−1, and the column vector (GH_{M}) is defined by correlation values [\tilde{g}ᵢ(t)\tilde{h}_{M}(t)], i=1, . . . , M−1. The quantity GG_{0M} is defined to be the correlation value \tilde{g}₀(t)\tilde{g}_{M}(t). The derivation of this equation is provided in Appendix A.

The embodiment shown in FIG. 3 is hereafter termed the “optimal” detector, because it maximizes the probability of making correct decisions for a given receive signal. In an FFT-based OFDM system, with K carriers and a fixed channel, there are 2^{K} possible waveforms that can be received. The optimum detector can be restated as a hypothesis-testing problem, with 2^{K} hypotheses corresponding to the possible waveforms given by each of the possible combinations of data bit on the carriers. The hypothesis that maximizes the likelihood function, or equivalently maximizes the probability of making a correct decision, is the output of this detector. This can be computed by determining the value of the likelihood function for each waveform and choosing the waveform corresponding to the maximum. The data associated with the chosen waveform is the output of the detector.

The limitation of the optimum detector for OFDM is its exponential complexity, which makes it difficult to implement with a large number of carriers. To address this issue, we propose a suboptimal MMSE detector below. The performance of the MMSE detector approaches that of the optimum detector and has only linear complexity, which allows it be easily implemented in practice.

The suboptimal method (hereafter termed the MMSE detector) reduces ICI by decorrelating carriers based on knowledge of the channel. The MMSE detector is the best linear receiver for OFDM systems. The MMSE receiver operates by passing the output of the matched filter through a linear filter, chosen such that the signature of the desired carrier, other carriers and the filter coefficients together have minimum cross correlation. The MMSE receiver exhibits a desired balance between interference removal and noise enhancement; it maximizes the signal-to-interference ratio (SIR) for each carrier. The linear transformation is a function of the channel cross correlation matrix and the signal to noise ratio for each carrier. Using channel estimates, the linear transform is computed and applied the to the output of the matched filter. The output of this transformation is the output of the detector.

FIG. 4 shows an embodiment of an OFDM receiver employing a MMSE detector. In this embodiment, the scaling mask 36 is replaced by a set of multi-carrier filters 402-406 designed to minimize the mean square error of the demodulated data values. Each filter calculates a weighted sum of the output values from the FFT module 34. Collectively, the filters implement a matrix multiplication, followed by a symbol decision. For an output vector rₘ=(r₀, r₁, . . . , r_{K-1})^{T} from the FFT module 34, the output \hat{d} from the set of filters is: \hat{d}=sgn(Mrₘ), where sgn is the signum (sign) function. Preferably, the matrix M is defined to be A⁻¹[R+σ²A⁻²]⁻¹, where R is a K×K correlation matrix between the carriers, σ² is the power of AWGN source 24, and A is a diagonal matrix diag(A₀, . . . , A_{K-1}) of scaling factors Aᵢ for the respective carriers at the time of transmission. Of course, when the signum function is used, the M matrix may be redefined without altering the result, e.g. the matrix M may be defined as [R+σ²A⁻²]⁻¹.

The R=[ρᵢⱼ] matrix may be calculated for the channel from the following expression:

$${ρ}_{i , j} = ⟨ {s}_{i} ∘ h , {s}_{j}^{*} ⟩ = ⟨ {\tilde{s}}_{i} , {s}_{j}^{*} ⟩ = {\sum }_{k = 0}^{K - 1} {\tilde{s}}_{i} ( k ) {s}_{j}^{*} ( k ) .$$

The frequency carriers are represented by sᵢ, the (shortened) impulse response of the channel is represented by h, the “^{o}” represents the convolution operation, the asterisk represents the complex conjugate, and the brackets represent the inner product operation.

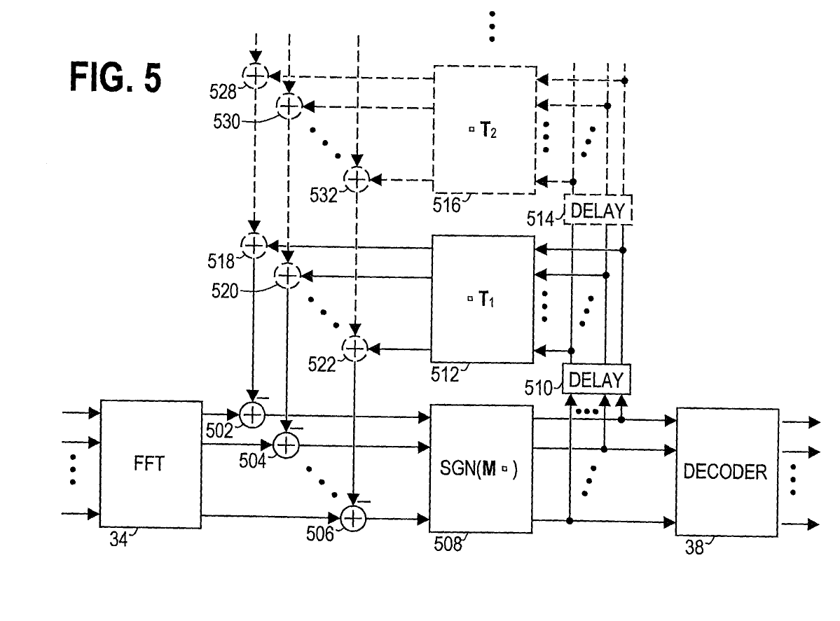

FIG. 5 shows a detector embodiment that extends the joint detection process across multiple OFDM symbols, to help combat ISI as well as ICI. As before, an FFT module 34 produces an output vector rₘ=(r₀, r₁, . . . , r_{K-1})^{T}. The ith component of this vector may be expressed in the following manner:

$${r}_{i} = [ X ( i ) {ρ}_{i , i} + {w}_{i} ] + {\sum }_{k \neq i}^{K - 1} X ( k ) {ρ}_{i , k} + {\sum }_{k = 0}^{K - 1} {X}_{1} ( k ) {ρ}_{1 , i , k} + …$$

In the above equation, X(i) represents the user data modulated on the ith carrier for the current symbol interval, X₁(i) represents the user data modulated on the ith carrier for the previous symbol interval, ρᵢⱼ represents the correlation between the ith channel-distorted carrier and the complex conjugate of the jth carrier, ρ_{1,ij} represents the correlation between the ith channel-distorted carrier in the previous symbol interval and the complex conjugate of the jth carrier in the current symbol interval, and wᵢ represents additive Gaussian noise associated with the ith component of the output vector.

The bracketed term of the above equation represents the desired information after the ISI and ICI have been removed. The next term of the above equation represents the ICI, and the remaining terms represent the ISI caused by trailing impulse response energy that remains uncorrected by the impulse response shortening filter and cyclic prefix. This approach may also be used in systems not having an impulse response shortening filter or a cyclic prefix.

In FIG. 5, the adders 502-506 subtract the ISI left over from previous symbol intervals. This ISI can be calculated (as explained in greater detail below) because the data from previous symbol intervals has already been received, and the channel impulse response is known. At the output of the adders, the signal vector still has ICI, which is corrected by ICI module 508. ICI module 508 may be implemented as described in FIG. 4, i.e. using a set of multi-carrier filters to implement a multiplication by matrix M, each followed by a decision element. The output of the ICI module 508 is the data for the current channel symbol. The data is provided to decoder 38 in the normal fashion, but is also used to calculate the ISI that corrupts the ensuing channel symbols.

To calculate the third term of the above equation, a delay latch 510 is used to retain the current data symbol for one symbol interval. The output of the delay latch 510 is the previous data symbol. A feedback module 512 implements the matrix multiplication t₁=x₁T₁, where x₁ is the row vector [X₁(k)] representing the data from the previous channel symbol, and T₁ is the correlation matrix [σ_{1,ij}]. The adders 502-506 implement the vector subtraction r-t₁.

If the ISI is severe enough to extend for more than one symbol, additional delay latches 514 and feedback modules 516 may optionally be added. The outputs of the additional feedback modules may be added using additional adders 518-522, 528-532 to obtain a total ISI term which may then be subtracted by adders 502-506.

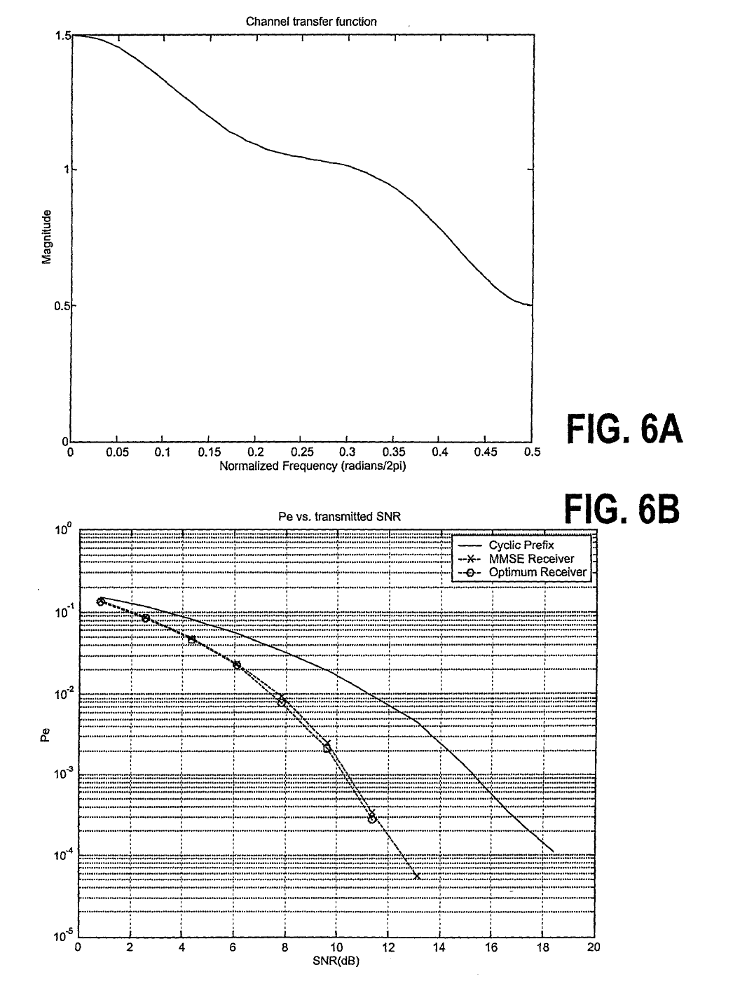

FIGS. 6-10 show a comparison of simulation results on various channels for the OFDM systems shown in FIG. 2 (cyclic prefix only), FIG. 3 (optimal) and FIG. 4 (MMSE). In each figure, the different channel spectra are shown, and the resulting error probability vs. signal-to-noise ratio (Pe vs. SNR) curves for each receiver are shown. The lower the error probability for a given SNR, the better the system performs. In general, the proposed embodiments offer greatly enhanced performance in terms of reduced probability of error. Further, in most cases the performance of the MMSE detector is comparable to the optimal detector. In those cases, the substantial reduction in implementation complexity offered by the MMSE detector would probably be a determining factor in designing a receiver.

In FIG. 6, the channel is exactly the length of the cyclic prefix. Recall that the combination of the cyclic prefix and scaling mask 36 is enough to completely eliminate ISI and ICI as long as the length of the channel does not exceed the length of the cyclic prefix. The drawback of this system, and all systems that attempt to completely invert channel effects, is noise amplification. In this example, the Pe vs. SNR curves of all three detection methods follow a Q-function, as expected (binary signaling in AWGN falls off as Q(sqrt(SNR)) ). The noise amplification of the cyclic prefix method is apparent and although there is no plateau in its performance (i.e. the function will continue falling for higher SNR), it cannot match the performance of the two joint detection methods. The computationally efficient MMSE detector in this case, performs virtually on par with the optimum detector.

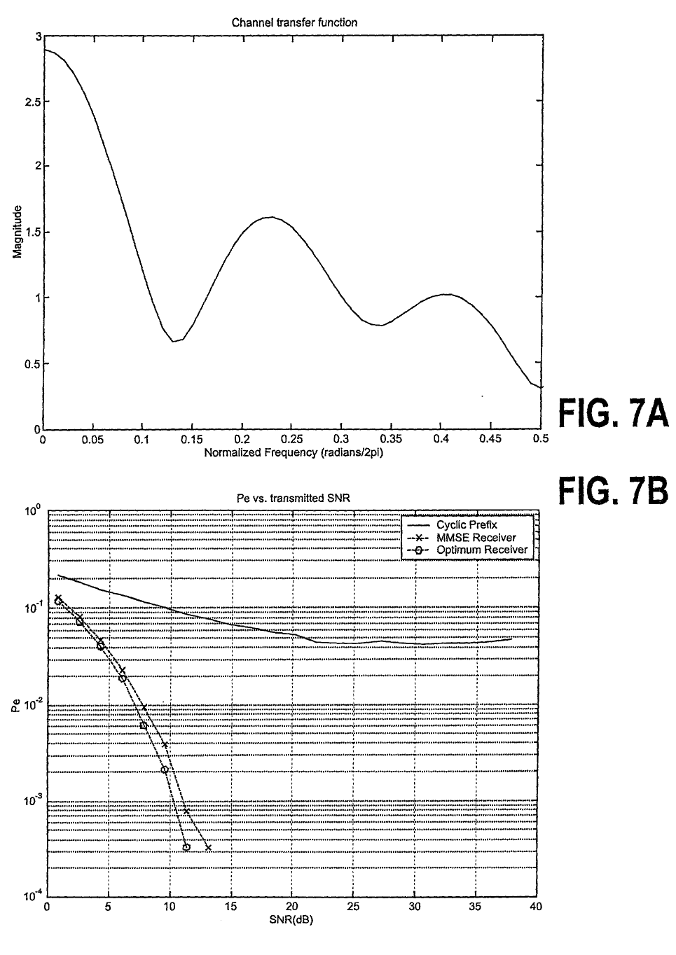

The situation depicted in FIG. 7 is similar to the first, except that the channel impulse response was 2 taps longer than the cyclic prefix, although 84% of the channel energy was kept within the cyclic prefix. This channel introduces both ISI and ICI that the detection schemes have to combat. It is apparent that the combination of the cyclic prefix and 1-tap equalizers is extremely ineffective. The significant ICI caused by lost orthogonality between subcarriers is more than the cyclic prefix system can combat. The joint detection schemes, however, perform very well in this situation. The fact that they do not rely on the guard interval to remove correlation between subcarriers, means they are better able to combat ICI.

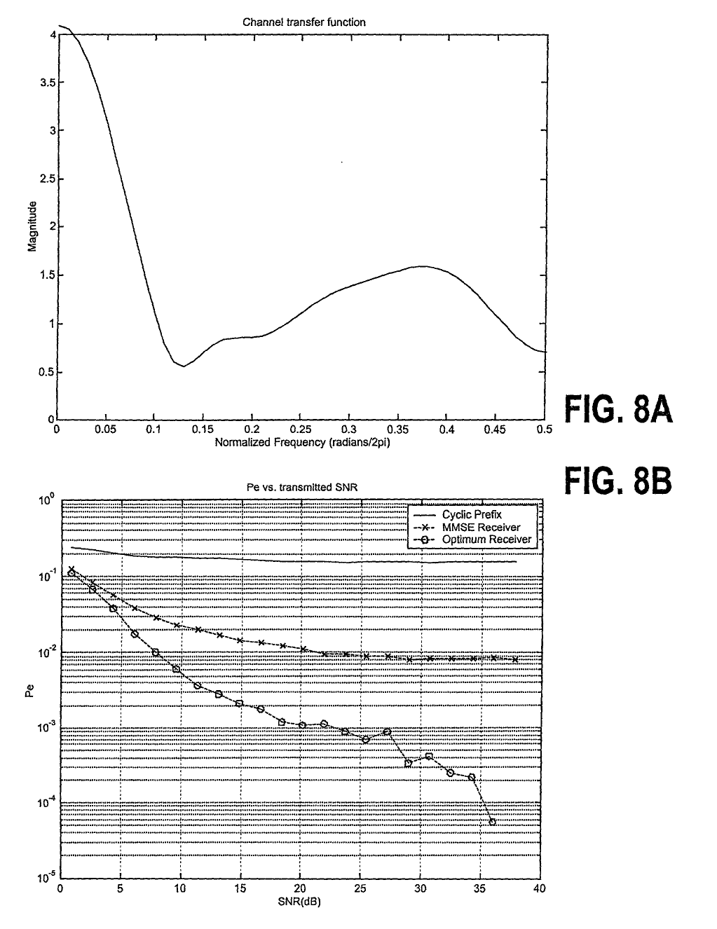

FIG. 8 illustrates the case where the channel is 4 taps longer than the cyclic prefix and 82% of channel energy is within the cyclic prefix. In addition to introducing ICI, this channel introduces appreciable ISI due to its longer delay spread. Since all three detection techniques are symbol-by-symbol methods, they cannot remove the ISI introduced from the previous OFDM symbols, which causes all three Pe vs. SNR curves to plateau. However, we can easily see that the joint detection methods are superior in removing ICI. This channel would be a good candidate for the receiver embodiment of FIG. 5 (which combats both ICI and ISI) because of the significant degradation caused by the presence of ISI. The ISI degradation is evident in the plateau-ing behavior of the performance curve.

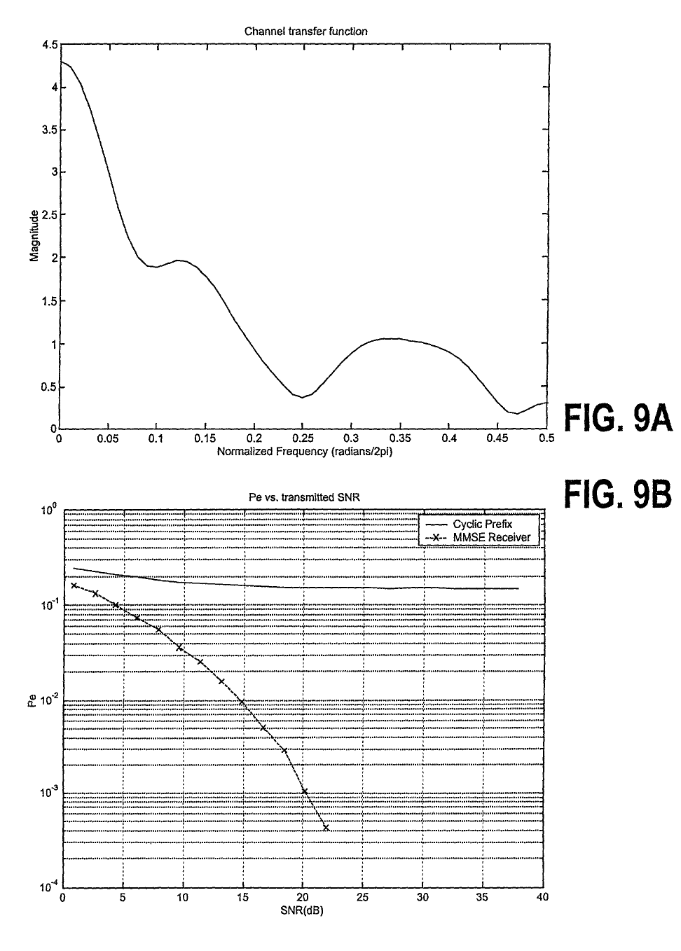

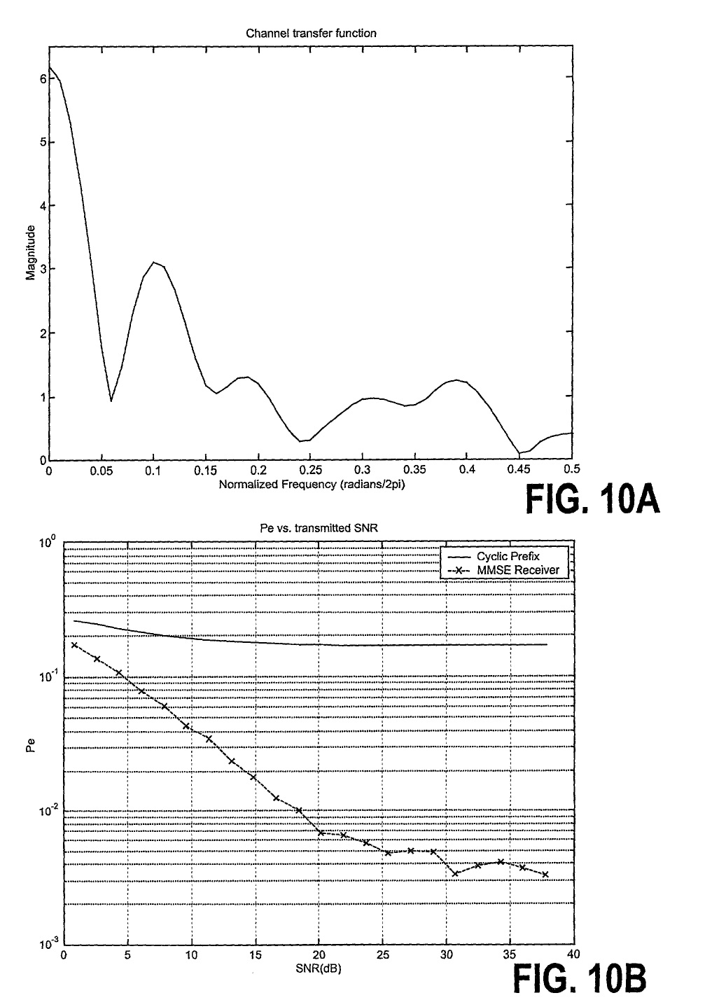

The examples illustrated in FIGS. 6-8 were shown for a system having a small number of subchannels. This allowed for simulation to determine the performance of the optimum detector, which has exponential complexity. However, the number of subchannels is unrealistically small for most OFDM systems. For a more realistic OFDM system having K=64, the exponential complexity of the optimal detector makes simulation infeasible. Accordingly, FIGS. 9-10 omit the optimal detector performance curve from the graph. In both the following systems, the cyclic prefix is set to 8 taps.

The length of the channel for the simulation shown in FIG. 9 is 11 taps, with 98% of the channel energy lying within the cyclic prefix guard interval. This channel introduces both ICI and ISI, however, since the length is longer than that of the cyclic prefix, the conventional method is not sufficient to remove both ISI and ICI. We can see that the MMSE detector, however, is able to effectively decorrelate the subcarriers, yielding improved performance.

For the simulation shown in FIG. 10, the channel length is 14 taps, with only 74% of the energy within the cyclic prefix. Unlike the previous example, this channel also introduces appreciable ISI as well as ICI. We can see the effect of ISI, as both curves plateau as SNR is increased. However, the MMSE detector performs better, as it is able to better remove ICI; its performance is mainly degraded by ISI. The traditional OFDM system, however, is significantly affected by both ISI and ICI, resulting in poorer performance. This channel would also be a good candidate for the receiver embodiment of FIG. 5, which combats both ICI and ISI.

These examples clearly illustrate the benefit of our proposed joint detection methods. The proposed joint detection methods remove ICI at the receiver without relying on the channel being shorter than the cyclic prefix. The MMSE receiver decorrelates the subcarriers, while the optimum receiver maximizes the probability of a correct decision by checking all possible combinations of data sequences. The significant performance improvement gained by the use of joint detection techniques and the relative ease of implementation of the suboptimal MMSE method, provide excellent justification of joint detection methods in OFDM systems, rather that the conventional combination of the cyclic prefix, matched filtering and 1-tap equalizers.

The above systems and simulations were performed using QPSK signaling on each of the carrier frequencies. Nevertheless, one of ordinary skill in the art will recognize that the techniques disclosed herein are readily applicable to multilevel QAM signaling and other modulation schemes on each of the carriers, and such applications are contemplated and intended to be within the scope of the ensuing claims.

Another contemplated variation of the OFDM system uses wavelet-based transforms in place of the Fourier Transforms. This variation is not expected to consistently outperform Fourier-Transform based systems, but it does offer some tradeoffs, such as the elimination of the cyclic prefix. The proposed joint detection methods also apply to wavelet-based OFDM systems.

Accordingly, significant performance gains can be made in any systems that use OFDM for data modulation and demodulation. As such, any technology that uses this technique can benefit. Specific examples of technology standards that specify this OFDM modulation include xDSL modem standards, wireless LAN standards, home networking standards, and digital satellite standards. Applications of the disclosed techniques may benefit these applications.

Numerous variations and modifications will become apparent to those skilled in the art once the above disclosure is fully appreciated. For example, the receivers may be implemented using, among other architectures, ASICs, firmware, and DSPs executing appropriate software. It is intended that the following claims be interpreted to embrace all such variations and modifications.

What is claimed is:

1. A communications receiver that comprises:
an analog-to-digital converter that samples a DMT (discrete multi-tone) signal to obtain a digital receive signal;
a transform module coupled to the analog-to-digital converter and configured to determine amplitudes associated with frequency components of the digital receive signal; and
a detection module configured to determine a channel symbol from the amplitudes while accounting for correlation between the amplitudes.

2. The receiver of claim 1, wherein the detection module determines the most probable channel symbol given the amplitudes determined by the transform module.

3. The receiver of claim 1, wherein the detection module includes:
a weighted sum unit associated with each frequency component, wherein each weighted sum unit combines a plurality of amplitudes from the transform module in a manner designed to minimize any error between the output of the weighted sum unit and a valid output value.

4. The receiver of claim 1, wherein the detection module determines the channel symbol that corresponds to a matrix product of a matrix M and a vector of amplitudes from the transform module, wherein the matrix M minimizes a square of an expected error between the channel symbol and valid channel symbols.

5. The receiver of claim 1, wherein the detection module includes:
a subtraction module that removes trailing intersymbol interference from the output of the transform module to obtain ISI-corrected frequency component values;
a decision unit that determines a matrix product of a matrix M and a vector of ISI-corrected frequency component values to obtain the channel symbol; and
a feedback module that determines a matrix product of a matrix T and the channel symbol from the decision unit to provide the trailing intersymbol interference to the subtraction module.

6. The receiver of claim 1, further comprising:
a time domain equalizer that operates on the digital receive signal to maximize a percentage of impulse response energy in a predetermined interval.

7. The receiver of claim 1, further comprising:
a cyclic prefix remover that removes prefixes from the digital receive signal, each prefix being associated with a respective channel symbol.

8. The receiver of claim 1, further comprising:
an error correction code decoder that decodes channel symbols received from the detection module.

9. The receiver of claim 1, wherein the transform module performs a fast Fourier Transform (FFT) on the receive signal in each channel symbol interval.

10. The receiver of claim 1, wherein the transform module includes a bank of matched bandpass filters.

11. A method of receiving OFDM (orthogonal frequency division multiplexing) modulated data, wherein the method comprises:
determining a set of frequency component amplitudes associated with a channel symbol interval of a receive signal; and
determining a channel symbol associated with the set of frequency component amplitudes while accounting for correlation between the amplitudes.

12. The method of claim 11, wherein said determining a channel symbol includes:
identifying a channel symbol that is most probably correct given the set of frequency component amplitudes.

13. The method of claim 11, wherein said determining a channel symbol includes:
for each frequency component:
calculating a weighted sum of frequency component amplitudes that minimizes expected error energy of the frequency component.

14. The method of claim 11, wherein said determining a channel symbol includes:
determining a product of a matrix M and the set of frequency component amplitudes, wherein the matrix M includes at least two non-zero values in each row.

15. The method of claim 11, wherein said determining a channel symbol includes:
subtracting intersymbol interference from the set of frequency component amplitudes to obtain an ISI-corrected set of frequency component amplitudes;
determining a product of a matrix M and the ISI-corrected set of frequency component amplitudes to obtain the channel symbol; and
determining a product of a matrix T and the channel symbol to obtain the intersymbol interference in a subsequent set of frequency component amplitudes.

16. The method of claim 11, further comprising:
processing the receive signal to shorten the effective channel impulse response before performing said determining a set of frequency component amplitudes.

17. The method of claim 11, further comprising:
removing a prefix from each symbol interval of the receive signal before performing said determining a set of frequency component amplitudes.

18. The method of claim 11, wherein said determining a set of frequency component amplitudes includes:
converting the receive signal into digital form; and
performing a fast Fourier Transform on the digital receive signal.

19. A communications system that comprises:
a transmitter that transmits an OFDM modulated signal; and
a receiver that receives and demodulates a corrupted version of the OFDM modulated signal, wherein the receiver includes:
an analog-to-digital converter that samples the corrupted OFDM-modulated signal to obtain a digital receive signal;
a transform module coupled to the analog-to-digital converter and configured to determine amplitudes associated with frequency components of the digital receive signal; and
a detection module configured to determine a channel symbol from the amplitudes while accounting for correlation between the amplitudes.

20. The system of claim 19, wherein the detection module determines the most probable channel symbol given the amplitudes determined by the transform module.

21. The system of claim 19, wherein the detection module includes:
a weighted sum unit associated with each frequency component, wherein each weighted sum unit combines a plurality of amplitudes from the transform module in a manner designed to minimize any error between the output of the weighted sum unit and a valid output value.

22. The system of claim 19, wherein the detection module determines the channel symbol that corresponds to a matrix product of a matrix M and a vector of amplitudes from the transform module, wherein the matrix M minimizes a square of an expected error between the channel symbol and valid channel symbols.

23. The system of claim 19, wherein the detection module includes:
a subtraction module that removes trailing intersymbol interference from the output of the transform module to obtain ISI-corrected frequency component values;
a decision unit that determines a matrix product of a matrix M and a vector of ISI-corrected frequency component values to obtain the channel symbol; and
a feedback module that determines a matrix product of a matrix T and the channel symbol from the decision unit to provide the trailing intersymbol interference to the subtraction module.
